(19) United States
(12) Patent Application Publication
(10) Pub. No.: US 2011/0128539 A1
(43) Pub. Date: Jun. 2, 2011

(54) METHOD FOR QUALITATIVE AND QUANTITATIVE DETERMINING ORGANIC COMPOUNDS OF PRECIOUS METALS IN VARIOUS COMPOSITION ROCKS

(76) Inventors: Andrei Filippovich Smetannikov, Perm (RU); Boris Lvovich Serebryaniy, Moscow (RU); Arkadiy Evgenievich Krasnoshtein, Perm (RU); Tatyana Froyanovna Weitzman, Perm (RU)

(21) Appl. No.: 12/452,260

(22) PCT Filed: Jul. 21, 2008
(86) PCT No.: PCT/RU2008/000478

§ 371 Date: Dec. 22, 2009

(30) Foreign Application Priority Data
Sep. 18, 2007 (RU) 2007134762

(51) Int. Cl. G01J 3/42

(52) U.S. Cl. 356/311

(57) ABSTRACT

A method is proposed for preparation of a sample of various rocks, containing organic compounds of precious metals (such as Au, Pt, and Pt). The sample is usable for further analysis of the metals content. The sample being analyzed is mixed with potassium chloride or sodium chloride in a ratio of 5-to-95 percent, and further subjected to assay fusion with litharge. The resulted entrapped cold shot is dissolved in aqua regia, and its dilute solution is analyzed by the known atomic-absorption method or by the known method of atomic emission with the use of plasma fixed by induction. This method makes it possible to preserve maximum of the metal components being analyzed, whereas the traditional methods of sample preparation cause loss of the most part of organic components containing the precious metals.

### CROSS-REFERENCE TO RELATED APPLICATIONS

This application is a U.S. national phase application of a PCT application PCT/RU2008/000478 filed on 21 Jul. 2008, published as WO2009/038496, whose disclosure is incorporated herein in its entirety by reference, which PCT application claims priority of a Russian Federation patent application RU2007/134762 filed on 18 Sep. 2007.

### FIELD OF THE INVENTION

This invention falls within the realms of analytical chemistry and may be applied to make quality and quantity measurement of organic metals compounds, namely, Au, Pt, and Pd, present in various types of rocks (including salt-containing rocks) and able to concentrate as organic compounds.

### BACKGROUND OF THE INVENTION

There are some recognized [known] methods devised by the CLAV GEOKHI, such as “Precious Metals. Determination of Their Content in Natural Subjects by Method of Electrothermic Atomic Absorption” (published in 1997), “Precious Metals. Determination of Their Content by Method of Atomic Emission with the Use of Plasma Fixed by Induction” (AES-ISP) and Method of Atomic Absorption (AAS)” (published in 1997), and methods devised by the CNIGRI, such as “Atomic Absorption Assaying of Various Rocks Containing Precious Metals”, as well as the following methods: MA 117-2 IATZ-45-2000 (IRGIREDMET) “Method for Measuring Fractions of Total Mass of Pt, Pd and Ro Present in Samples of Pt-Containing Rocks and Products of Their Processing by Atomic Absorption Assaying”, MA 117-2 IATZ043-2000 (IRGIREDMET) “Method for Measuring Fractions of Total Mass of Au and Ag Present in Samples of Au-Containing Rocks and Products of Their Processing by Atomic Absorption Assaying” and NSAM 482 “Method for Measuring Content of Au in Lean Placers, Gravitation Tailings and Products of Processing of Sand-Gravel Mixtures by Atomic Absorption Assaying”.

Preparation (decomposition and “mineralization”) of samples for the above methods involves the following operations:

To make analysis with the use of the AES-ISP and AAS methods it is necessary to put a previously weighed one-gram-sample in fluoroplastic sleeve (cup) (150 ml) of titanium autoclave and pour 4 ml of nitric acid (HNO₃)+4 ml of hydrochloric acid (HCl)+4 ml of hydrogen peroxide (H₂O₂) into the sample. Leave the mixture for 4 hours at 220° C. Then transfer the contents of the sleeve [cup] into a glass-carbon cup, add 15 ml of hydrofluoric acid (HF), place the mixture on hot plate (stove) and evaporate to dryness. To remove vapours of fluorine add 5 ml of hydrochloric acid (HCl), evaporate the mixture to dryness and mix in 15 ml of aqua regia in the ratio of 1 HNO₃ to 3 HCl. Evaporate the mixture to wet (moist) salts, add 5 ml of hydrochloric acid (HCl) and evaporate again to wet [moist] salts so that to remove all vapours of nitrogen dioxide (NO₂). Transfer the contents to solution using binomial hydrochloric acid (2N HCl). Next step is extraction (methyl isobutyl ketone) to determine the content of gold (Au) or sorption (Polyorgs-IV sorbent) to determine the content of platinum (Pt) and palladium (Pd).

To make analysis with the use of atomic absorption assaying mix a previously weighed sample (50-200 g) with litharge (lead oxide) and subject the mixture to assay fusion (smelting) at 950-1200° C. While reducing to metal the litharge (lead oxide) collects precious metals to form a lead bullion ingot. At the next stage heat the lead bullion in a “font” i.e. a bowl made of porous refractory (magnesite, bone meal)—up to 900-1200° C. Once lead has been absorbed by the porous refractory it leaves entrapped cold shot—micro-ingot containing all precious metals that were present in the material being analyzed—on the surface of the font. Then dissolve the entrapped cold shot in aqua regia (mixture of HNO₃ and HCl) and make atomic-absorption analysis of dilute acid solution to determine the whole range of precious metals, that is to say, this method uses assay fusion (smelting) and preparation of entrapped cold shot in order to concentrate precious metals.

Results of the analysis of samples containing compounds of Au, Pt, and Pd carried out with preparation (decomposition) by the above methods are unreliable for the following reasons:

1) in the course of decomposition by traditional methods, organic compounds of Au, Pt, and Pd are lost (gone to sublimates, etc.), and are not present in the solution being analyzed;
2) sample components (compounding materials) being analyzed are non-uniformly distributed; and
3) organic compounds of Au, Pt, and Pd are being modified.

### BRIEF DESCRIPTION OF THE INVENTION

This invention resolves the issue of preparation of samples for analysis of organic compounds of Au, Pt, and Pd present in various types of rocks and guarantees very reliable results.

Precious metals present in salt-containing rocks of Verkhnekamskoje field are represented by organic compounds of Au, Pt, and Pd incorporated into water-insoluble residue of salt-containing rocks, and, in case of ore processing, also into water-insoluble residue of argillo-saline waste (slurry). When the water-insoluble residue is separated from salt (saline) matrix, the structure and composition of its organic components are modified which is manifested as blocking the organic compounds of Au, Pt, and Pd, their aggregation, modification of the composition and rearrangement in the water-insoluble residue of salt-containing rock. As a consequence, the sampling method and correct analysis (assaying) of precious metals in the water-insoluble residue of salt-containing rocks and products of their processing do not work properly.

Depending on the type of rock (black shale, cupreous sandstones, etc.) precious metals may be fixed to an organic substance comprising from 0.5 to 1.5% of the rock. As a rule, a correct analysis to determine the content of precious metals in the rocks is unfeasible by virtue of the fact that upon decomposition of sample (preparation of material for the analysis) the most part of metals, especially Pt and Pd, is lost.

In view of the above-mentioned peculiarities of the material being analyzed a concept of analysis of such compounds has been developed that resulted in creation of a method for preparation of sample to the analysis. A traditional method for preparation of samples with chloride matrix involves, first of all, a separation of the matrix and a transfer of water-insoluble residue into solution. In case of salt-containing rocks, the entire sample material is transferred to the solution. According to the present invention, an initial (reference) sample is mixed with potassium (K) chloride or sodium (Na) chloride in a ratio of 5 to 95. To put it otherwise, the sample material amounts to 5%, while the portion of potassium chloride or sodium chloride makes up 95%.

This preparation method is closely related to a particular analysis technique—atomic-absorption assaying. The essence of the method lies with preliminary mixing of material being analyzed with litharge (lead oxide) and its assay fusion (at 900-1200° C.), during which lead, while being reduced, causes concentration of precious metals (i.e. collects precious metals). This process relates to assay concentration. The obtained ingot (lead bullion) is subjected to heating in a bowl preferably made of a porous refractory material—magnesite resulting in absorption of the lead by the porous material and formation of an entrapped cold shot (micro-ingot or metallic bead), in which the precious metals are concentrated on the surface of the bowl. The entrapped cold shot is dissolved in a concentrated solution of aqua regia, after which the dilute solution is analyzed by the atomic-absorption method.

### DETAIL DESCRIPTION OF A PREFERRED EMBODIMENT OF THE INVENTION

While the invention may be susceptible to embodiment in different forms, it will be described in detail herein, a specific embodiment of the present invention, with the understanding that the present disclosure is to be considered an exemplification of the principles of the invention, and is not intended to limit the invention to that as illustrated and described herein.

According to the present invention, the material being analyzed, which contains organic compounds of precious metals, is mixed with potassium chloride or sodium chloride in the ratio of 5 to 95, and only after that the resultant furnace-charge is mixed with litharge (lead oxide). During the assay fusion of the mixture, a concentration of precious metals occurs. The chloride matrix along with the annealing of organic compounds prevents the precious metal from being lost to sublimates serving as a shielding screen for the metals. Hence, the key principle of this method is the heating of the analyzed material to a predeterminedly high temperature in the presence of the chloride matrix and a concentrating agent, represented by litharge. Then the obtained ingot (lead bullion) is subjected to heating in the bowl, and the entrapped cold shot (metallic bead) is dissolved in aqua regia, and analyzed by the atomic-absorption method or by a method of atomic emission with the use of plasma fixed by induction.

The proposed inventive method of sample preparation together with the assay concentration in the presence of the chloride matrix makes it possible to preserve a maximum of precious metals (Au, Pt, Pd) present in organic compounds. On the other hand, the traditional methods of sample preparation, which involve decomposition of the samples and their transfer to the solution, cause loss of the most part of components being analyzed.

To get the above technical result, the sample is subjected to assay fusion with litharge mixed with potassium chloride or sodium chloride in the ratio of 5 to 95.

The feature that distinguishes this inventive method from the above-mentioned and most similar one, is the fact that the sample is subjected to the assay fusion with litharge mixed with potassium chloride or sodium chloride in the ratio of 5 to 95.

The proposed method suggests that the analysis should take into consideration the amount of material being analysed which comprises 5%, while the remaining 95% fall on the mixture of potassium chloride or sodium chloride and litharge within the temperature range from 950 to 1200° C.

Nanoparticles of the organic compounds of Au, Pt, and Pd are annealed, and the metals are concentrated as lead bullion, which is then heated in the bowl and transformed into the entrapped cold shot. Then the shot is dissolved in aqua regia, and subjected to analysis by the traditional atomic spectrum methods. In other words, in the course of sample preparation the precious metals are wholly transferred to the solution being analyzed without any losses.

To illustrate: after the atomic-absorption assaying of salt-containing rock (marking clay) containing 5-10% of sodium chloride (NaCl), the content of precious metals (Au, Pt, Pd) is lower than a detection threshold (refer to Table 1, top part), whereas after the same analysis of the sample mixed with sodium chloride in the ratio of 5 to 95, the result increases by a factor of 10² (refer to Table 1, bottom part).

TABLE 1

| | Content, g/ton | | | |
|---|---|---|---|---|
| Samples | Au | Pt | Pd | Total |

Marking clays (MC), reference

| | | | |
|---|---|---|---|
| Reference marking clay (water- | 0.05 | 0.01 | 0.01 |
| insoluble residue - 95%, NaCl - 5%0 | | | |

Marking clays mixed with NaCl

| | | | |
|---|---|---|---|
| Mixture (NaCl - 95%, marking clay - 5%) | 0.012 | 0.084 | 0.31 |

Marking clays

| | | | | |
|---|---|---|---|---|
| In terms of reference marking clay | 0.3 | 0.63 | 3.4 | 4.33 |
| (water-insoluble residue - 95%) | | | | |

TABLE 2

| | | Previously | Content, g/ton | | | |
|---|---|---|---|---|---|---|
| No | Sample | weighed sample, g | Au | Pt | Pd | Total |
| 1 | Rock salt | 50 | <0.01 | 0.036 | 0.092 | |
| | [halite], lean | | | | | |
| 2 | MC-7 | 50 | 0.016 | 0.076 | 0.19 | 3.1 |
| | | | 0.32 | 0.8 | 2.0 | |
| 3 | MC-8 | 50 | 0.030 | 0.070 | 0.22 | 3.9 |
| | | | 0.6 | 0.68 | 2.6 | |
| 4 | MC-10 | 50 | 0.026 | 0.067 | 0.20 | 3.1 |
| | | | 0.52 | 0.31 | 2.2 | |
| 5 | MC-13 | 50 | 0.035 | 0.074 | 0.46 | 8.3 |
| | | | 0.7 | 0.38 | 7.2 | |
| 6 | MC-14 | 50 | 0.030 | 0.078 | 0.31 | 5.4 |
| | | | 0.6 | 0.42 | 4.4 | |
| 7 | MC-15 | 50 | 0.12 | 0.046 | 0.22 | 5.2 |
| | | | 2.4 | 0.2 | 2.6 | |

A test of this method made with the use of 7 samples of marking clay (MC) taken within the range from 200 to 400 m (Table 2) has confirmed the correctness of the inventive method.

Notes: Sample 1—lean rock salt (blank control sample of rock salt). Samples 2-8—furrow samples of marking clay. The numerator represents the result of analysis of the mixed sample (marking clay mixed with rock salt in the ratio 5 to 95), and the denominator represent the result of analysis in terms of reference marking clay.

TABLE 3

| | Content, g/ton | | | |
|---|---|---|---|---|
| Samples | Au | Pt | Pd | Total |

Reference rocks (black shale)

| | | | | |
|---|---|---|---|---|
| T/a 3508, reference | <0.05 | 0.073 | 0.23 | 0.303 |
| T/a 4201, reference | <0.05 | 0.16 | 0.24 | 0.4 |

Rocks mixed with NaCl

| | | | | |
|---|---|---|---|---|
| T/a 3508 + rock salt | <0.05 | 0.028 | 0.089 | — |
| (in the ratio 5:95) | | | | |
| T/a 4201 + rock salt | <0.05 | 0.046 | 0.078 | — |
| (in the ratio 5:95) | | | | |

In terms of reference rock

| | | | | |
|---|---|---|---|---|
| T/a 3508 in terms of reference rock | — | 0.34 | 0.94 | 1.28 |
| (100% of reference rock) | | | | |
| T/a 4201 in terms of reference rock | — | 0.7 | 0.72 | 1.42 |
| (100% pf reference rock) | | | | |

Analysis of samples of salt-free rocks with a high content of organic compounds of precious metals (refer to Table 3) has revealed the same pattern (relationship), that is to say, the inventive sample preparation method may be applied to all natural subjects containing precious metals, especially to platinoides in the form of organic compounds.

Thus, in view of the obtained results, the methodological approach to determination of content of Au, Pt, and Pd present in various rocks as organic compounds has been changed.

1. The method of quantity and quality measurement of organic compounds of precious metals containing in various types of rocks that involves previous weighing of material being analyzed, assay fusion of its mixture with litharge, dissolution of entrapped cold shot in aqua regia and atomic-absorption analysis of acid solution distinguishing from other methods by assay fusion of the sample together with litharge mixed with potassium chloride (K) or sodium chloride (Na) in the ratio of 5 to 95.
